(19) United States
(12) Patent Application Publication
(10) Pub. No.: US 2014/0047511 A1
(43) Pub. Date: Feb. 13, 2014

(54) NETWORK STORAGE SYSTEM AND METHOD THEREOF

(71) Applicant: CHING-PIN WANG, Tu-Cheng (TW)

(72) Inventor: CHING-PIN WANG, Tu-Cheng (TW)

(73) Assignee: HON HAI PRECISION INDUSTRY CO., LTD., Tu-Cheng (TW)

(21) Appl. No.: 13/593,477

(22) Filed: Aug. 23, 2012

(30) Foreign Application Priority Data
Aug. 9, 2012 (TW) 101128797

(51) Int. Cl. G06F 21/00

(52) U.S. Cl. 726/4

(57) ABSTRACT

A network storage system includes a user data storage area, a public storage area, and a processor. The user data storage area includes a number of private storage areas for storing private data of users. Each private storage area is designated for a registered account. The public storage area stores a plurality of identifiers (IDs) of the private storage areas and a plurality of deletion codes each of which corresponds to a registered account and comprises a deletion ID and a user ID. The processor identifies the code is a deletion code when one of the deletion IDs is contained in the code, determines the corresponding registered account of the identified deletion code according to the user ID, further determines the corresponding private storage area of the determined registered account, and deletes all the data stored in the determined private storage area.

### BACKGROUND

1. Technical Field

The present disclosure relates to a network storage system, and particularly to a system for protecting the security of the data stored in a network server and a method using the same.

2. Description of Related Art

With the development of networks, user often stores data to a network storage system. However, if an account and password are obtained by an unauthorized user, the data stored in the network storage system can be obtained by the unauthorized user. The unauthorized user can even change the login information to prevent the legitimate user from logging into the network storage system or contact the administrator.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a block diagram of a network storage system and an environment of the network storage system in accordance with one embodiment.

FIG. 2 is a flowchart of a method for securely deleting the data stored in the network storage system of FIG. 1.

### DETAILED DESCRIPTION

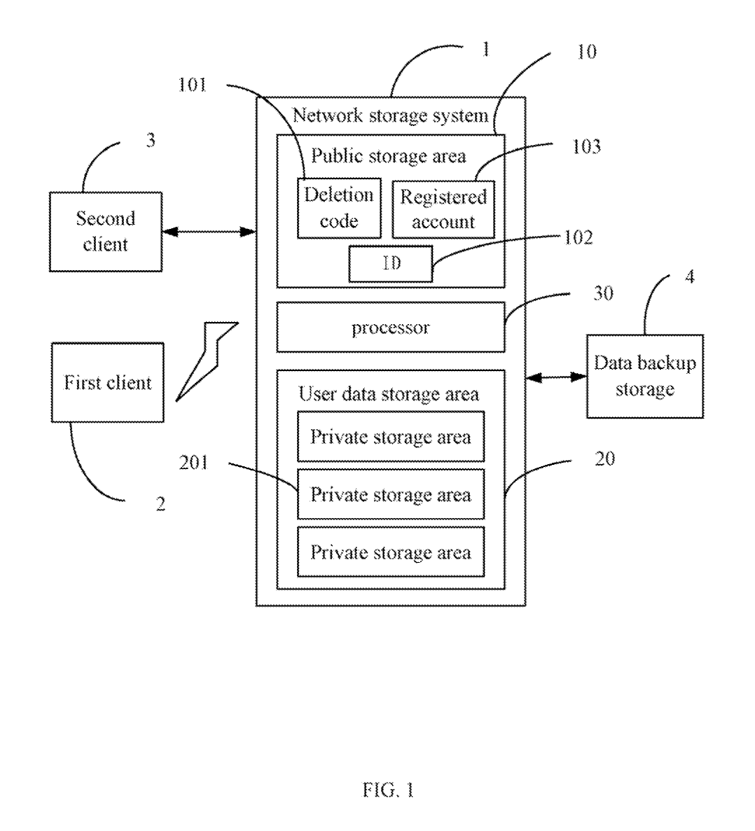

FIG. 1 is a block diagram of a network storage system 1 and an environment of the network storage system 1 in accordance with one embodiment. The network storage system 1 includes a public storage area 10, a user data storage area 20, and a processor 30. The user data storage area 20 includes a number of private storage areas 201 for storing private data of users. Each private storage area 201 is designated an identifier (ID) 102 for locating one of the private storage areas 201. The IDs 102 of all the private storage areas 201 are stored into the public storage area 10. When the user successfully registers to the network storage system 1, the network storage system 1 designates one private storage area 201 for a registered account 103 of the authorized user, associates the registered account 103 and the ID 102 of the designated private storage area 201, and stores the association of the registered account 103 and the ID 102 to the public storage area 10. The user registered to the network storage system 1 is an authorized user.

A first client 2, such as a mobile phone, is capable of connecting to the network storage system 1 through a wireless network. The second client 3, such as a computer, is capable of connecting to the network storage system 1 through a wired or wireless network. After successfully registering to the network storage system 1, the private data of the authorized user can be transmitted to the designated private storage area 201 of the registered account 103 through the first client 2 or the second client 3.

The public storage area 10 further stores a number of deletion codes 101. Each deletion code 101 is designated for one registered account 103. The deletion code 101 can be designated for each registered account 103 or only for the registered account 103 which is upgraded (such as registered accounts of paying users). The deletion code 101 includes a deletion ID and a user ID. The deletion ID is for identifying the deletion code 101 is for implementing a deletion operation. The user ID is associated with the registered account 103 and can be used to determine the corresponding registered account 103 and further determine which private storage area 201 is implemented the deletion operation. In the embodiment, the deletion operation is an operation for deleting all the data stored in the private storage area 201.

The deletion code 101 can be sent by the first client 2. For example, if the authorized user cannot log in the network storage system 1 using the registered account 103 and password, which can means that the network storage system 1 is logged in by an unauthorized user, the authorized user can send the deletion code 101 through the first client 2 to the network storage system 1.

In other embodiment, after the registered account 103 is logged in the network storage system 1 each time, the network storage system 1 sends a message to the first client 2 of the authorized user. If the first client 2 receives the message when the authorized user is not logged in the network storage system, that means that the private storage area 201 may be logged in by the unauthorized user. The authorized user can send the deletion code 101 through the first client 2 to the network storage system 1 at once.

The first client 2 can send the deletion code 101 to the network storage system 1 by two ways. For example, the first client 2 edits a message including the deleting code 101 and sends the message to the network storage system 1 in the first way. In the second way, the first client 2 installs an application for automatically sending the deletion code 101 when the application is implemented in response to user's operation.

When receiving a code from the first client 2, the processor 30 first identifies whether the deletion ID is included in the code to determine whether the code is a deletion code 101. If identifying the received code is the deletion code 101, the processor 30 determines the corresponding registered account 103 of the deletion code 101 according to the user ID included in the deletion code 101, further determines the associated private storage area 201 of the determined registered account 103, deletes all the data stored in the determined private storage area 201, and send a deletion notice to the administrator of the network storage system 1.

In the embodiment, the network storage system 1 further includes a data backup storage 4. The data backup storage 4 is used for backing up the data stored in the user data storage area 20 regularly. The data backup storage 4 is connected to the network storage system 1 only when data exchange, such as data backup or data recovery, between the data backing up storage 4 and the network storage system is required. Thereby, the data stored in the data backup storage 4 can be secure.

When the deletion notice is received by the administrator, the administrator forcibly logs out the registered account 103 and recovers the private data of the private storage area 201 of the registered account 103 from the data backup storage 4. After the private data of the private storage area 201 is recovered, if detecting the private storage area 201 is logged in by the registered account 103 and password, the processor 30 outputs a series of predetermined questions to identify the user. If all the questions are answered correctly, the processor 30 designates a new account and password to the user, and the user can log in the network storage system 1 using the new account and password.

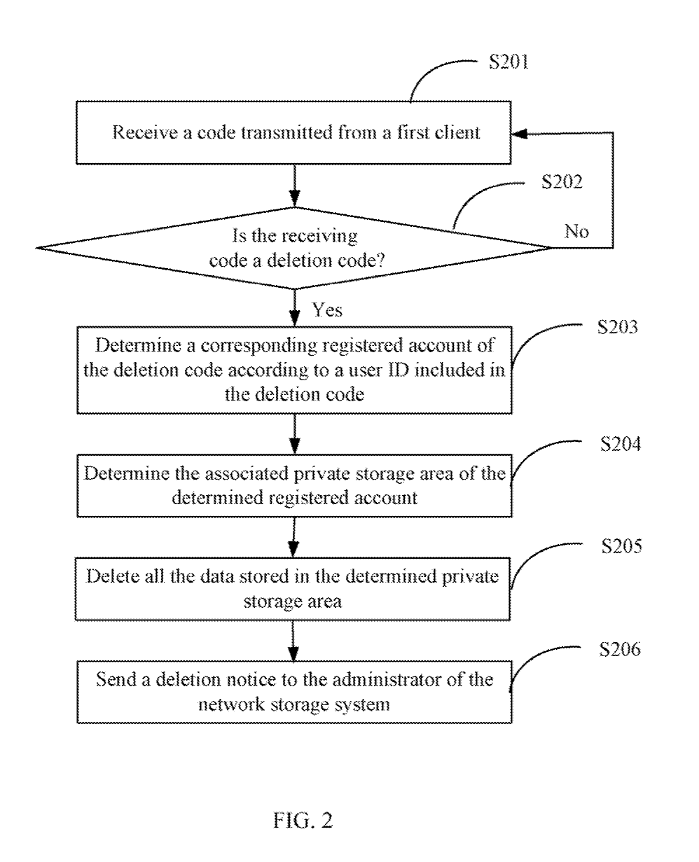

FIG. 2 is a flowchart of a method for deleting the data stored in the network storage system 1 of FIG. 1.

In step S201, the processor 30 receives a code transmitted from the first client 2.

In step S202, the processor 30 further identifies whether the received code is a deletion code 101 by determining whether the deletion ID is included in the received code. If the deletion ID is not included in the received code, namely the received code is not the deletion code 101, the procedure goes back to the step S201.

In step S203, if the received code is the deletion code 101, the processor 30 further determines the corresponding registered account 103 of the deletion code 101 according to the user ID included in the deletion code 101.

In step S204, the processor 30 further determines the associated private storage area 201 of the determined registered account 103.

In step S205, the processor 30 deletes all the data stored in the determined private storage area 201.

In step S206, the processor 30 sends a deletion notice to the administrator of the network storage system 1.

In the embodiments, after the private data of the private storage area 201 is recovered, if detecting the private storage area 201 is logged in by the registered account 103 and password, the processor 30 outputs a series of predetermined questions to identify the user. If all the questions are answered correctly, the processor 30 designates a new account and password to the authorized user.

Although the present disclosure has been specifically described on the basis of preferred embodiments, the disclosure is not to be construed as being limited thereto. Various changes or modifications may be made to the embodiment without departing from the scope and spirit of the disclosure.

What is claimed is:

1. A network storage system comprising:
a user data storage area comprising a plurality of private storage areas for storing private data of users, wherein each of the plurality of private storage area is designated for a registered account of an authorized user who has registered with the network storage system;
a public storage area for storing:
a plurality of deletion codes each of which corresponds to a registered account and comprises a deletion identifier (ID) and a user ID, wherein the deletion ID is for identifying the deletion code, the user ID is associated with a corresponding registered account; and
a plurality of IDs of the private storage areas each of which corresponds to a registered account, wherein each of the plurality of IDs is for locating one of the private storage areas; and
a processor for receiving a code from a client, identifying that the code is a deletion code when one of the deletion IDs is contained in the code, determining the corresponding registered account of the identified deletion code according to the user ID comprised in the deletion code, further determining the corresponding private storage area of the determined registered account, and deleting all the data stored in the determined private storage area.

2. The network storage system as described in claim 1, wherein the processor further sends a deletion notice to an administrator of the network storage system after all the data stored in the determined private storage is deleted.

3. The network storage system as described in claim 2, further comprising a data backup storage for backing up the data stored in the user data storage area regularly, wherein the data backup storage is connected to the network storage system only when the data exchange between the data backup storage and the network storage system is required.

4. The network storage system as described in claim 3, wherein the processor forcibly logs out the corresponding registered account of the private storage area and recovers the private data of the private storage area from the data backup storage in response to an administrator's operation when the deletion notice is received by the administrator.

5. The network storage system as described in claim 4, wherein after the private data of the private storage area is recovered, if detecting the private storage area is logged in by the registered account and password, the processor outputs a series of predetermined questions to identify the user and designates a new account and password to the user if all the questions are answered correctly.

6. The network storage system as described in claim 1, wherein the deletion code is sent by the client when the authorized user fails to log in the network storage system using the registered account and password.

7. The network storage system as described in claim 1, wherein the processor sends a message to the client of the authorized user after the network storage system is logged in each time.

8. A method for deleting the data stored in the network storage system comprising:
storing private data of users in a plurality of private storage areas of a user data storage area of the network storage system, wherein each of the plurality of private storage area is designated for a registered account of an authorized user who has registered with the network storage system;
storing a plurality of deletion codes in a public storage area, wherein each of the plurality of deletion code corresponds to a registered account and comprises a deletion identifier (ID) and a user ID, the deletion ID is for identifying the deletion code, the user ID is associated with a corresponding registered account;
storing a plurality of IDs of the private storage areas each of which corresponds to a registered account, wherein each of the plurality of IDs is for locating one of the private storage areas;
receiving a code from a client;
identifying that the code is a deletion code when one of the deletion IDs is contained in the code;
determining the corresponding registered account of the identified deletion code according to the user ID comprised in the deletion code;
further determining the corresponding private storage area of the determined registered account; and
deleting all the data stored in the determined private storage area.

9. The method as described in claim 8, further comprising sending a deletion notice to an administrator of the network storage system after all the data stored in the determined private storage is deleted.

10. The method as described in claim 9, further comprising backing up the data stored in the user data storage area regularly in a data backup storage of the network storage system.

11. The method as described in claim 10, further comprising forcibly logging out the corresponding registered account of the private storage area and recovering the private data of the private storage area from the data backup storage in response to the administrator's operation when the deletion notice is received by the administrator.

12. The method as described in claim 11, wherein after the private data of the private storage area is recovered, outputting a series of predetermined questions to identify the user if detecting the private storage area is logged in by the registered account and password if detecting the private storage area is logged in by the registered account and password, and designating a new account and password to the user if all the questions are answered correctly.

13. The method as described in claim 8, wherein the deletion code is sent by a client when the user is failure to log to the network storage system using the registered account and password.

14. The method as described in claim 8, further comprising sending a message to a client of the authorized user after the network storage system is logged in each time.
